(19) United States
(12) Patent Application Publication
(10) Pub. No.: US 2016/0209693 A1
(43) Pub. Date: Jul. 21, 2016

(54) DISPLAY DEVICE

(71) Applicant: Samsung Display Co., Ltd., Yongin-City (KR)

(72) Inventors: Si Kwang KIM, Daegu (KR); Tae Woon CHA, Seoul (KR); Seung-Yeon CHAE, Hwaseong-si, Gyeonggi-do (KR)

(21) Appl. No.: 14/881,021

(22) Filed: Oct. 12, 2015

(30) Foreign Application Priority Data
Jan. 21, 2015 (KR) 10-2015-0010083

(51) Int. Cl. G02F 1/1339; G02F 1/1333; G02F 1/1337; G02F 1/1343; G02F 1/1368

(52) U.S. Cl. CPC G02F 1/13394; G02F 1/134309; G02F 1/1368; G02F 1/1337; G02F 1/133371

(57) ABSTRACT

A display device may include a substrate, a roof layer, a pixel electrode, a liquid crystal layer, and a support member. The roof layer may overlap the substrate. The pixel electrode may be positioned between the roof layer and the substrate. The liquid crystal layer may be positioned between the roof layer and the pixel electrode and may include a first liquid crystal portion and a second liquid crystal portion. The first liquid crystal portion may be smaller than the second liquid crystal portion. The support member may be positioned between the roof layer and the substrate and may be positioned between the first liquid crystal portion and the second liquid crystal portion.

### CROSS-REFERENCE TO RELATED APPLICATION

This application claims priority to and the benefit of Korean Patent Application No. 10-2015-0010083 filed in the Korean Intellectual Property Office on Jan. 21, 2015; the entire contents of the Korean Patent Application are incorporated herein by reference.

### BACKGROUND

(a) Field

The technical field is related to a display device, such as a liquid crystal display device.

(b) Description of Related Art

A display device may utilize electricity for displaying images. For example, a liquid crystal display (LCD) device may generate electric fields, by applying different voltages to pixel electrodes and a common electrode, for controlling orientations of liquid crystal molecules to control light transmittance, thereby displaying images. The display device may include a first substrate for supporting the pixel electrodes and may include a second substrate for supporting the common electrode. These two substrates may undesirably add to weight, thickness, cost, and/or manufacturing time associated with the display device.

The above information disclosed in this Background section is for enhancement of understanding of a background related to the invention. The Background section may contain information that does not form the prior art that is already known in this country to a person of ordinary skill in the art.

### SUMMARY

An embodiment may be related to a display device. The display device may include a substrate, a first roof layer, a pixel electrode, a liquid crystal layer, and a first support member. The first roof layer may overlap the substrate. The pixel electrode may be positioned between the first roof layer and the substrate. The liquid crystal layer may be positioned between the first roof layer and the pixel electrode and may include a first liquid crystal portion and a second liquid crystal portion. The first liquid crystal portion may be smaller than the second liquid crystal portion. The first support member may be positioned between the first roof layer and the substrate and may be positioned between the first liquid crystal portion and a second liquid crystal portion.

The liquid crystal layer may surround four sides of the first support member.

Each of the first liquid crystal portion and the second liquid crystal portion may overlap the pixel electrode in a direction perpendicular to the substrate.

The display device may include a semiconductor, which may be electrically connected to the pixel electrode. The display device may include a data line, which may be electrically connected to the semiconductor. The first support member may be positioned between the first liquid crystal portion and the second liquid crystal portion in a direction parallel to the data line.

The pixel electrode may include a first subpixel electrode and a second subpixel electrode. The liquid crystal layer may overlap the first subpixel electrode. The first liquid crystal portion may be positioned closer to the second subpixel electrode than the second liquid crystal portion.

The display device may include a semiconductor, which may be electrically connected to the pixel electrode. The display device may include a data line, which may be electrically connected to the semiconductor. The first support member may be positioned between the first liquid crystal portion and the second liquid crystal portion in a direction perpendicular to the data line.

The liquid crystal layer may include a third liquid crystal portion and a fourth liquid crystal portion. The third liquid crystal portion may be smaller than the fourth liquid crystal portion. The first support member may be positioned between the third liquid crystal portion and the fourth liquid crystal portion in a direction parallel to the data line.

A first side of the first liquid crystal portion may be positioned between a second side of the first liquid crystal portion and the substrate. A first side of the second liquid crystal portion may be positioned between a second side of the second liquid crystal portion and the substrate. The second side of the first liquid crystal portion may be positioned closer to the substrate than the second side of the second liquid crystal portion.

A first side of the first liquid crystal portion may be positioned between a second side of the first liquid crystal portion and the substrate. A first side of the second liquid crystal portion may be positioned between a second side of the second liquid crystal portion and the substrate. The second side of the first liquid crystal portion may be narrower than the second side of the second liquid crystal portion.

The display device may include a second support member. The liquid crystal layer may include a third liquid crystal portion. The third liquid crystal portion may be positioned between the first liquid crystal portion and the second liquid crystal portion in the direction perpendicular to the data line. The first support member may be positioned between the first liquid crystal portion and the third liquid crystal portion in the direction perpendicular to the data line. The second support member may be positioned between the third liquid crystal portion and the second liquid crystal portion in the direction perpendicular to the data line.

The third liquid crystal portion may be larger than the first liquid crystal portion.

The third liquid crystal portion may be smaller than the second liquid crystal portion.

A first side of the first liquid crystal portion may be positioned between a second side of the first liquid crystal portion and the substrate. A first side of the third liquid crystal portion may be positioned between a second side of the third liquid crystal portion and the substrate. The second side of the first liquid crystal portion may be narrower than the second side of the third liquid crystal portion.

A first side of the third liquid crystal portion may be positioned between a second side of the third liquid crystal portion and the substrate. A first side of the second liquid crystal portion may be positioned between a second side of the second liquid crystal portion and the substrate. The second side of the third liquid crystal portion may be positioned closer to the substrate than the second side of the second liquid crystal portion.

A first side of the third liquid crystal portion may be positioned between a second side of the third liquid crystal portion and the substrate. A first side of the second liquid crystal portion may be positioned between a second side of the second liquid crystal portion and the substrate. The second side of the first liquid crystal portion may be wider than the second side of the second liquid crystal portion.

The display device may include a common electrode, which may overlap the pixel electrode. A portion of the common electrode may be positioned between the third liquid crystal portion and the second support member and may directly contact each of the third liquid crystal portion and the second support member.

The display device may include an alignment layer, which directly contact the liquid crystal layer and may orient a direction of a liquid crystal molecule in the liquid crystal layer. A portion of the alignment layer may be positioned between the third liquid crystal portion and the first support member and may directly contact each of the third liquid crystal portion and the first support member.

The display device may include a common electrode, which may overlap the pixel electrode. A portion of the common electrode may be positioned between the second liquid crystal portion and the first support member and may directly contact each of the second liquid crystal portion and the first support member.

The display device may include a second roof layer, which may be aligned with the first roof layer in an alignment direction. The pixel electrode may include a first subpixel electrode and second subpixel electrode. The first roof layer may overlap the first subpixel electrode. The second roof layer may overlap the second subpixel electrode. A first portion of the first roof layer may overlap the first support member in a direction perpendicular to the substrate. A second portion of the first roof layer may not overlap the first support member in the direction perpendicular to the substrate. The first portion of the first roof layer may be positioned between the second roof layer and the second portion of the first roof layer in the alignment direction. The first portion of the first roof layer may be narrower than the second portion of the first roof layer in a direction perpendicular to the alignment direction.

The display device may include a second support member. A first portion of the second roof layer may overlap the second support member in the direction perpendicular to the substrate. A second portion of the second roof layer may not overlap the second support member in the direction perpendicular to the substrate. A distance between the first portion of the first roof layer and the first portion of the second roof layer may be smaller than a distance between the second portion of the first roof layer and the second portion of the second roof layer in the alignment direction.

An embodiment may be related to a display device. The display device may include the following elements: a substrate in which a thin film transistor is disposed; a pixel electrode connected to the thin film transistor; a roof layer that is separated from the pixel electrode; a liquid crystal layer; a microcavity containing the liquid crystal layer, positioned between the roof layer and the pixel electrode, and having an injection hole; a supporting member that overlaps the roof layer and is adjacent to the injection hole; and a stepped portion that overlaps the roof layer and extends between the supporting member and a lateral side of the microcavity.

There are one or more supporting members.

The stepped portion may be shorter than the supporting member in a direction perpendicular to the substrate.

The stepped portion may be formed in a line shape with the same width as the supporting member.

The stepped portion and the supporting member may be made of the same material.

The stepped portion and the supporting member may be made of the same material as the roof layer.

The supporting member may be formed in a pillar shape.

The display device may further include: a common electrode formed below the roof layer; a first alignment layer formed on the pixel electrode; and a second alignment layer formed below the common electrode.

The display device may further include an overcoat formed on the roof layer to cover the injection hole.

An embodiment may be related to a display device. The display device may include the following elements: a substrate in which a thin film transistor is disposed; a pixel electrode connected to the thin film transistor; a roof layer that is separated from the pixel electrode and includes an extension, wherein the extension is narrower than another portion of the roof layer; a liquid crystal layer; a microcavity containing the liquid crystal layer, positioned between the roof layer and the pixel electrode, and having an injection hole; a supporting member formed below the extension; and a stepped portion that protrudes from a lower surface of the extension and extends from the supporting member to an edge of the extension.

A width of the extension in a row direction may be narrower than a width of the microcavity in a row direction.

According to embodiments, a display device may be manufactured with a single substrate. Advantageously, thickness, weight, cost, and/or manufacturing time associated with the display device may be minimized.

According to embodiments, unwanted elements (e.g., lumps and/or bubbles) may be effectively removed in a process of manufacturing a display device. Advantageously, defects in the display device may be minimized, and images displayed by the display device may be satisfactory.

According to embodiments, a support member may effectively prevent deformation of a roof layer in a display device. Advantageously, the display device may have a satisfactorily robust structure.

### BRIEF DESCRIPTION OF THE DRAWINGS

FIG. 1 is a schematic plan view (or schematic layout view) illustrating elements and/or structures in a display device according to an embodiment.

FIG. 2 is a schematic plan view (or schematic layout view) illustrating elements and/or structures in a display device according to an embodiment.

FIG. 3 is a schematic cross-sectional view taken along line III-III indicated in FIG. 1 according to an embodiment.

FIG. 4 is a schematic cross-sectional view taken along line IV-IV indicated in FIG. 1 according to an embodiment.

FIG. 5 is a schematic plan view (or schematic layout view) illustrating a display device according to an embodiment.

FIG. 6 is a cross-sectional view taken along line VI-VI indicated in FIG. 5 according to an embodiment.

FIG. 7 is a schematic plan view (or schematic layout view) illustrating a display device according to an embodiment.

FIG. 8 is a cross-sectional view taken along line VIII-VIII indicated in FIG. 7 according to an embodiment.

### DETAILED DESCRIPTION OF EMBODIMENTS

Some embodiments are described with reference to the accompanying drawings. As those skilled in the art would realize, the described embodiments may be modified in various ways.

Although the terms “first”, “second”, etc. may be used herein to describe various elements, these elements, should not be limited by these terms. These terms may be used to distinguish one element from another element. Thus, a first element discussed below may be termed a second element without departing from the teachings of the present invention. The description of an element as a “first” element may not require or imply the presence of a second element or other elements. The terms “first”, “second”, etc. may also be used herein to differentiate different categories or sets of elements. For conciseness, the terms “first”, “second”, etc. may represent, for example, “first-category (or first-set)”, “second-category (or second-set)”, etc., respectively.

In the drawings, thicknesses of layers, films, panels, regions, etc., may be exaggerated for clarity. Like reference numerals may designate like elements. When a first element (such as a layer, film, region, or substrate) is referred to as being “on” a second element, the first element can be directly on the second element, or one or more intervening elements may also be present. When a first element is referred to as being “directly on” a second element, there are no intended intervening elements between the first element and the second element.

The term “connect” may mean “electrically connect”. The term “insulate” may mean “electrically insulate”. The term “distance” may mean “minimum distance”.

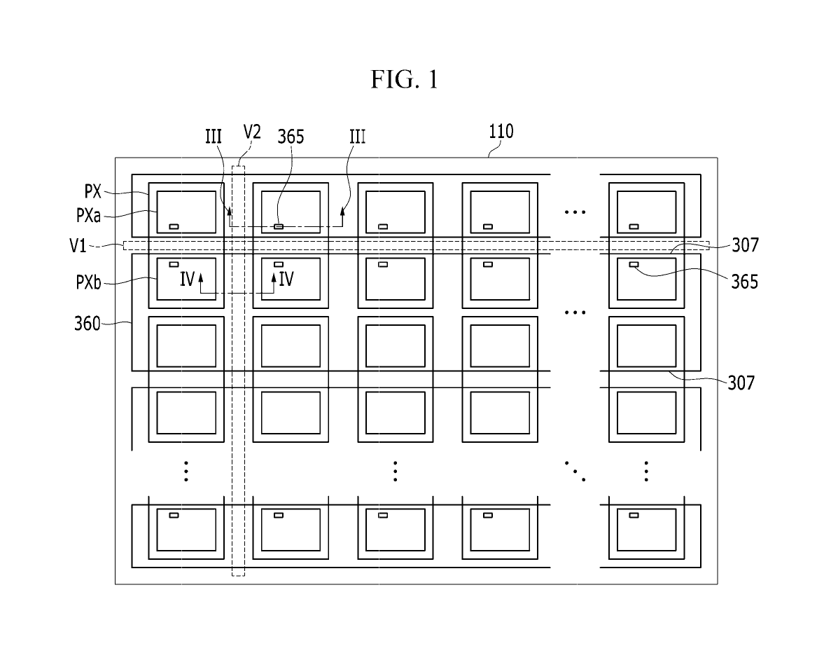

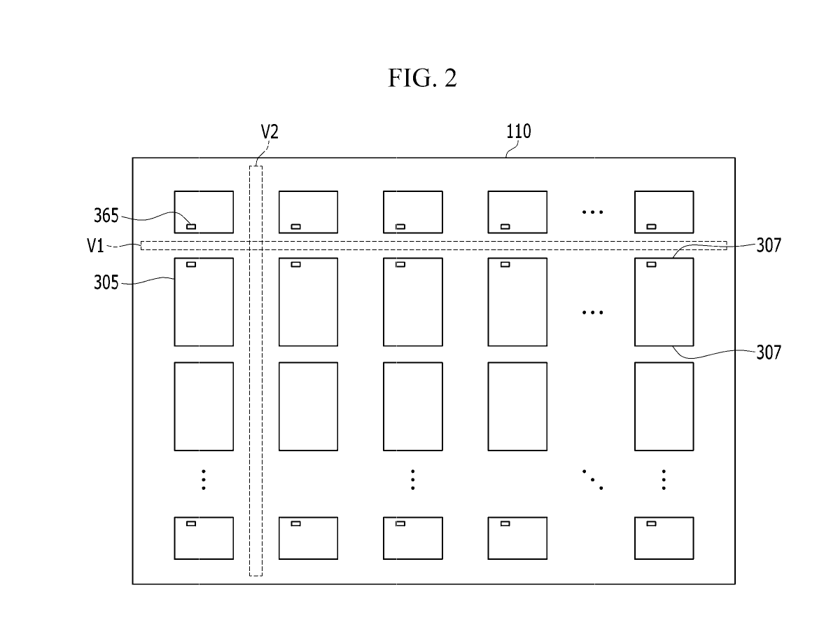

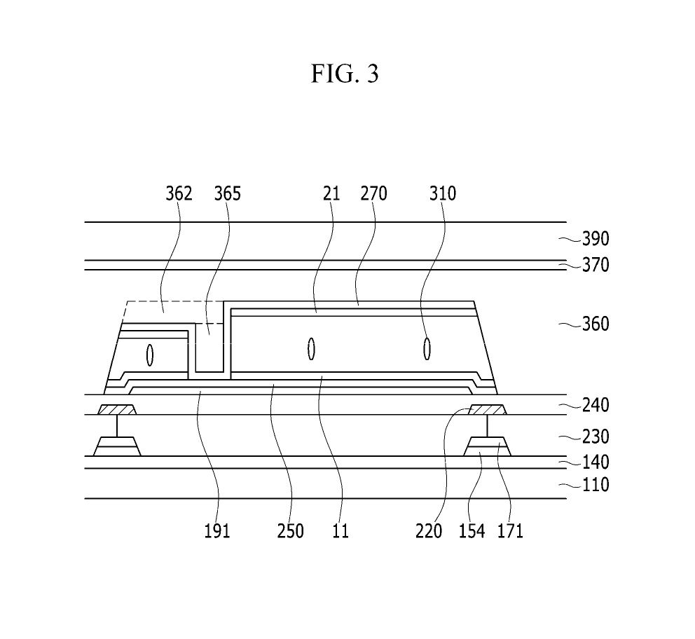

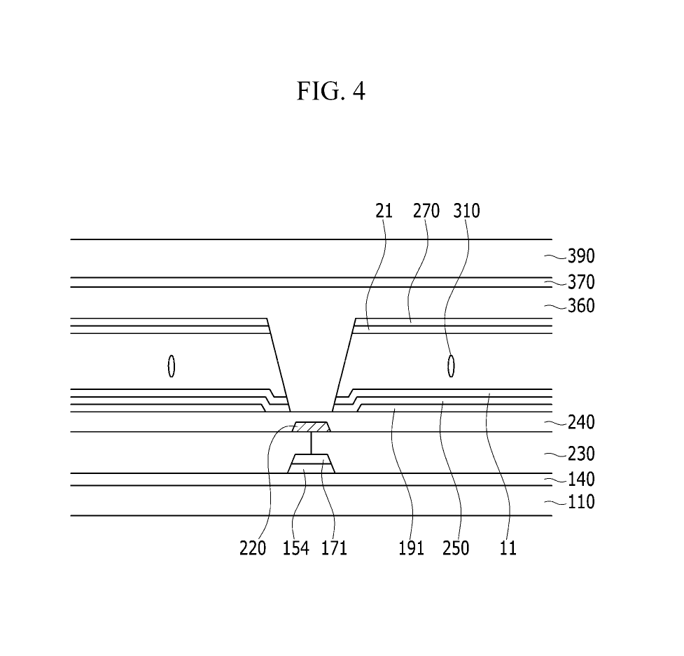

FIGS. 1 and 2 are schematic plan views (or schematic layout views) illustrating elements and/or structures in a display device according to an embodiment. FIG. 1 illustrates positions of support members 365 with reference to pixel areas PX. FIG. 2 illustrates positions of support members 365 with reference to microcavities 305. FIG. 3 is a schematic cross-sectional view taken along line III-III indicated in FIG. 1 according to an embodiment. FIG. 4 is a schematic cross-sectional view taken along line IV-IV indicated in FIG. 1 according to an embodiment.

The display device includes a substrate 110, which may be made of glass or plastic. The display device may include one or more roof layers 360 positioned (and formed) on the substrate 110.

The substrate 110 includes a plurality of pixels (or pixel areas) PX. In the specification, the term “pixel(s)” may mean “pixel area(s).”

The pixels PX are disposed in a matrix (or array) that includes a plurality of pixel rows and a plurality of pixel columns. Each pixel PX may include a first-type subpixel PXa (or first subpixel PXa for conciseness) and a second subpixel PXb (or second subpixel PXb for conciseness). The first subpixel PXa may be aligned with the second subpixel PXb in a pixel column direction.

A first-type valley V1 (or first valley V1) is positioned between a first subpixel PXa and a second subpixel PXb and extends in a pixel row direction. A second-type valley V2 (or second valley V2) is positioned between two pixel columns.

The display device may include a data line 171. The data line 171 may transmit data voltages to some pixels PX. Cross-sections of the data line 171 are illustrated in FIG. 3 and FIG. 4. The data line 171 may extend parallel to pixel columns, may extend parallel to second valleys V2, and/or may overlap a second valley V2.

The display device may include a semiconductor 154. Cross-sections of the semiconductor 154 are illustrated in FIG. 3 and FIG. 4. The semiconductor 154 may be positioned between the data line 171 and the substrate 110 and may directly contact the data line 171.

Roof layers 360 may extend along pixel rows. In an embodiment, spaces may exist between roof layers 360 and may exist at first valleys V1 for enabling liquid crystal material to be provided through injections hole 307 into microcavities 305 covered by the roof layers 360.

Each of a first subpixel PXa and a second subpixel PXb may have one injection hole 307. In an embodiment, an injection hole 307 of a first subpixel PXa is positioned at a side of the first subpixel PXa that faces a second subpixel PXb, the injection hole 307 of the second pixel PXb is positioned at a side of the second subpixel PXb that faces the first subpixel PXa, and thus the two injection holes 307 face each other.

Each injection hole 307 may contain a liquid crystal layer, which may include liquid crystal molecules 310. FIG. 3 and FIG. 4 illustrate portions of liquid crystal layers.

A support member 365 is positioned (and formed) adjacent to an injection hole 307 below a roof layer 360. The support member 365 may effectively support the roof layer 360 and may substantially prevent the roof layer 360 from sagging near the injection hole 307. The support member 365 may be positioned between a first portion of a liquid crystal layer and a second portion of the liquid crystal layer in a direction parallel to the data line 171. The first portion of a liquid crystal layer may be positioned closer to the injection hole than the second portion of the liquid crystal layer and may be smaller than the second portion of the liquid crystal layer.

The support member 365 may be positioned between a first side of a microcavity 305 and a second side of the microcavity in a pixel row direction. The supporting member 365 may be positioned closer to the first side of the microcavity 305 than to the second side of the microcavity (in the pixel row direction). The support member 365 may be positioned between a third portion of a liquid crystal layer and a fourth portion of the liquid crystal layer in a direction perpendicular to the data line 171. The third portion of a liquid crystal layer may be smaller than the fourth portion of the liquid crystal layer. The liquid crystal layer may surround four sides of the support member 365.

Two support members 365 are formed at opposite edges of two microcavities 305 that immediately neighbor each other in the pixel column direction. A first valley V1 may be positioned in the two support members 365 in a plan view of the display device.

Microcavities 305 are disposed in a matrix (or array) that includes microcavity rows and microcavity columns. A microcavity 305 may have a quadrangular shape in a plan view of the display device. Support members 365 are positioned (and formed) near or at immediately neighboring edges of immediately neighboring microcavity rows.

Two injection holes 307 may be positioned (and formed) at two opposite edges of a microcavity 305. For example, a first edge of a microcavity 305 may be opposite a second edge of the microcavity 305 and may be aligned with the second edge of the microcavity 305 in the microcavity column direction. A first injection hole 307 may be positioned at the first edge of the microcavity 305, and a second injection hole 307 may be positioned at the second edge of the microcavity 305. In an embodiment, a support member 365 may be positioned at or adjacent to the first injection hole 307. No support member 365 may be formed at the second injection hole 307.

In an embodiment, each pixel area PX may be associated with one microcavity 305, instead of two microcavities 305. Referring to FIGS. 3 and 4, the display device includes the substrate 110, a gate insulation layer 140, a plurality of semiconductors 154, a plurality of data lines 171, and a passivation layer 230. The display device may include gate lines that are insulated from the data lines 171 by the gate insulating layer 140. The passivation layer 230 may be a color filter layer and may include a red filter, a green filter, and a blue filter.

A plurality of light blocking members 220 and a first insulating layer 240 are disposed on the passivation layer 230. The first insulating layer 240 may be made of an inorganic insulating material, such as a silicon nitride (SiNx) and/or a silicon oxide (SiOx). The first insulating layer 240 may protect the color filter layer 230 (which may be made of one or more organic materials) and the light blocking members 220. In an embodiment, the first insulating layer 240 may be omitted if necessary.

A light blocking member 220 may overlap a data line 171. The first insulating layer 240 covers the light blocking members 220, and the top surface of the first insulating layer 240 may be substantially flat.

A pixel electrode 191 made of a transparent metal material, such as indium tin oxide (ITO) and/or indium zinc oxide (IZO), may be disposed on the first insulating layer 240. The pixel electrode 191 may be electrically connected to a semiconductor 154 (e.g., in a manner known in the art) and may be electrically connected through the semiconductor 154 to a data line 171 (e.g., in a manner known in the art) for receiving a data voltage. The pixel electrode 191 may include a first subpixel electrode and a second subpixel electrode. The first subpixel electrode may be positioned in a first subpixel PXa. The second subpixel electrode may be positioned in a second subpixel PXb.

A second insulating layer 250 may be formed on the pixel electrode 191. The second insulating layer 250 may be made of an inorganic insulating material such as a silicon nitride (SiNx) and/or a silicon oxide (SiOx). The second insulating layer 250 may protect the pixel electrode 191. In an embodiment, the second insulating layer 250 may be omitted.

A common electrode 270 may overlap the pixel electrode 191 and may be spaced from the pixel electrode 191 by a predetermined distance. A microcavity 305 is formed between the second insulating layer 250 and the common electrode 270. A width and an area of the microcavity 305 may be configured according to a size and/or a resolution of the display device.

The second insulating layer 250 may prevent short circuit potentially caused by contact between the common electrode 270 and the pixel electrode 191.

In an embodiment, the common electrode 270 may be formed directly on the second insulating layer 250. The common electrode 270 may be positioned between a microcavity 305 and the second insulating layer 250.

The common electrode 270 may be made of a transparent metal material, such as indium tin oxide (ITO) and/or indium zinc oxide (IZO). A predetermined voltage may be applied to the common electrode 270, and an electric field may be generated between the pixel electrode 191 and the common electrode 270.

A first alignment layer 11 is formed on the pixel electrode 191 and/or the second insulating layer 250. A second alignment layer 21 is formed on the common electrode 270 and faces the first alignment layer 11.

The first alignment layer 11 and the second alignment layer 21 may be vertical alignment layers and may be made of one or more alignment materials, such as polyamic acid, polysiloxane, and/or polyimide.

A liquid crystal layer that includes liquid crystal molecules 310 is formed in the microcavity 305 positioned between the pixel electrode 191 and the common electrode 270. The liquid crystal molecules 310 have negative dielectric anisotropy and may be oriented in a substantially vertical direction, i.e., substantially perpendicular to the substrate 110, when no electric field is applied. A roof layer 360 is formed on the common electrode 270. The roof layer 360 may be made of an organic material. The microcavity 305 is formed below the roof layer 360, and the roof layer 360 is hardened by a curing process to maintain a shape of the microcavity 305. The roof layer 360 is spaced from the pixel electrode 191 with the microcavity 305 (and liquid crystal molecules 310) being positioned between the roof layer 360 and the pixel electrode 191.

The roof layer 360 may cover subpixels PXa and/or subpixels PXb in one or more pixel rows and may cover portions of second valleys V2 positioned between these subpixels PXa and/or subpixels PXb. The roof layer 360 may not substantially overlap any first valley V1, which is positioned between a first subpixel PXa and a second subpixel PXb. A microcavity 305 may be formed below a roof layer 360 in a first subpixel PXa or a second subpixel PXb. A portion of a roof layer 360 positioned at a second valley V2 may separate two microcavities 305 that immediately neighbor each other in the pixel row direction. A thickness of a portion of a roof layer 360 positioned at a second valley V2 may be larger than a thickness of a portion of the roof layer 360 positioned at a first subpixel PXa and/or a thickness of a portion of the roof layer 360 positioned at a second subpixel PXb. Sides of a microcavity 305 may be covered by a roof layer 360.

An injection hole 307 exposing a part of a microcavity 305 is formed in a roof layer 360, as described above. Materials for forming the aligning layers 11 and 21 and/or the liquid crystal molecules may be provided into the microcavity 305 through the injection hole 307.

A support member 365 may be positioned inside a microcavity 305, may be positioned adjacent to an injection hole 307 of the microcavity 305, and may have a pillar shape. Two support members 365 may be respectively formed at two opposite edges of two immediately neighboring microcavities 305.

In an embodiment, the supporting member 365 may be positioned closer to one side of the microcavity 305 than to another side of the microcavity 305 in the pixel row direction. In an embodiment, the support member 365 may be positioned at a midpoint between two opposite sides of the microcavity 305 in the pixel row direction.

The support member 365 may be directly connected to the roof layer 360 and may be made of the same material as the roof layer 360. A portion of the common electrode 270 may be disposed between the supporting member 365 and a pixel electrode 191. In an embodiment, the support member 365 may be made of a material different from a material of the roof layer 360. In an embodiment, no portion of the common electrode 270 may be disposed between the support member 365 and a pixel electrode 191. In an embodiment, the support member 365 may directly contact the pixel electrode 191, the second insulating layer 250, and/or the first insulating layer 240.

The support member 365 may have a quadrangular shape in a plan view of the display device. In an embodiment, support members 365 may have one or more other shapes, such as a circular shape and/or a triangular shape, in a plan view of the display device.

In an embodiment, a stepped portion 362 may be positioned at a first side (e.g., left side) of the support member 365, such that a first portion of the microcavity 305, which is positioned at the first side (e.g., left side) of the support member 365, may be substantially smaller (e.g., shorter and/or narrower) than a second portion of the microcavity 305, which is positioned at a second side (e.g., right side) of the support member 365, in a direction perpendicular to the pixel electrode 191 and/or perpendicular to the substrate 110. The asymmetrical structure in the microcavity 305 may cause a capillary force at the first portion of the microcavity 305 to be greater than a capillary force at the second portion of the microcavity 305 when materials are provided into the microcavity 305 for forming the alignment layer 11, the alignment layer 21, and/or the liquid crystal layer (which includes liquid crystal molecules 310). As a result, unwanted elements, such as lumps and/or bubbles, that are formed during supply of the alignment material and/or the liquid crystal material may substantially concentrate at the small first portion of the microcavity 305 (and/or at the first side of the support member 365) and may be effectively removed in the process of manufacturing the display device. Advantageously, defects in the display device may be minimized.

The support member 365 may be positioned at or near an injection hole 307 of the microcavity 305 and/or may be positioned near the abovementioned unwanted elements. Therefore, an edge of the roof layer 360 may be sufficiently supported, such that sagging of the edge of the roof layer 360 may be substantially prevented. Advantageously, the display device may have a robust structure.

In the display device, a first portion of the liquid crystal layer (or first liquid crystal portion), a first portion of the alignment layer 11, and a first portion of the alignment layer 21 may be positioned at the first side of the support member 365. A second portion of the liquid crystal layer (or second liquid crystal portion), a second portion of the alignment layer 11, and a second portion of the alignment layer 21 may be positioned at the second side of the support member 365. The first portion of the liquid crystal layer, the first portion of the alignment layer 11, the first portion of the alignment layer 21, the second portion of the liquid crystal layer, the second portion of the alignment layer 11, and/or the second portion of the alignment layer 21 may overlap the same pixel electrode 191.

The first portion of the liquid crystal layer (or first liquid crystal portion) may be shorter than the second portion of the liquid crystal layer (or second liquid crystal portion) in the direction perpendicular to the pixel electrode 191 and/or perpendicular to the substrate 110. A first side (e.g., lower side) of the first liquid crystal portion may be positioned between a second side (e.g., upper side) of the first liquid crystal portion and the substrate 110. A first side (e.g., lower side) of the second liquid crystal portion may be positioned between a second side (e.g., upper side) of the second liquid crystal portion and the substrate 110. The second side of the first liquid crystal portion may be positioned closer to the substrate 110 than the second side of the second liquid crystal portion in the direction perpendicular to the substrate 110. The second side of the first liquid crystal portion may be narrower than the second side of the second liquid crystal portion in a direction perpendicular to a data line 171, in the pixel row direction and/or in the microcavity row direction.

A distance between the first portion of the alignment layer 11 and the first portion of the alignment layer 21 may be shorter than a distance between the second portion of the alignment layer 11 and the second portion of the alignment layer 21 in the direction perpendicular to the pixel electrode 191 and/or perpendicular to the substrate 110. The alignment layer 11 may be positioned between the alignment layer 21 and the pixel electrode 191. The first portion of the alignment layer 21 may be positioned closer to the pixel electrode 191 (and/or the substrate 110) than the second portion of the alignment layer 21.

The first portion of the microcavity 305, the first portion of the liquid crystal layer, the first portion of the alignment layer 11, and the first portion of the alignment layer 21 may be respectively narrower than the second portion of the microcavity 305, the second portion of the liquid crystal layer, the second portion of the alignment layer 11, and the second portion of the alignment layer 21 in the pixel row direction and/or in the microcavity row direction.

A first portion of the common electrode 270 may be positioned between the first liquid crystal portion and the support member 365. A second portion of the common electrode 270 may be positioned between the second liquid crystal portion and the support member 365.

The stepped portion 362 may be positioned at a top side of the microcavity 305. The stepped portion 362 may extend from the supporting member 365 to a lateral wall of the microcavity 305 and may be a beam structure positioned at the top portion of the microcavity 305. A dimension of the stepped portion 362 may be less than a dimension of the supporting member 365 in the direction perpendicular to the substrate 110. A dimension of the stepped portion 362 may be equal to a dimension of the supporting member 365 in the pixel column direction.

The stepped portion 362 may be made of the same material as the supporting member 365. In an embodiment, the stepped portion 362, the supporting member 365, and the roof layer 360 may be made of the same material.

A third insulating layer 370 may be formed on the roof layer 360. The third insulating layer 370 may be made of an inorganic insulating material, such as a silicon nitride (SiNx) and/or a silicon oxide (SiOx). The third insulating layer 370 may cover a top surface and a lateral surface of the roof layer 360. The third insulating layer 370 may protect the roof layer 360. In an embodiment, the third insulating layer 370 may be omitted.

An overcoat 390 may be formed on the third insulating layer 370. The overcoat 390 may cover the injection holes 307. That is, the overcoat 390 may seal the microcavity 305 to prevent leakage of the liquid crystal molecules 310. Since the overcoat 390 contacts the liquid crystal molecules 310, the overcoat 390 may be made of a material that does not substantially chemically react with the liquid crystal molecules 310. For example, the overcoat 390 may be made of parylene and/or one or more other suitable materials.

The overcoat 390 may have a multilayer structure, such as a double layer structure or a triple layer structure. The double layer structure may include two layers made of different materials. The triple layer structure may include three layers, wherein materials of adjacent layers are different from each other. For example, the overcoat 390 may include a layer made of an organic insulating material and/or a layer made of an inorganic insulating material.

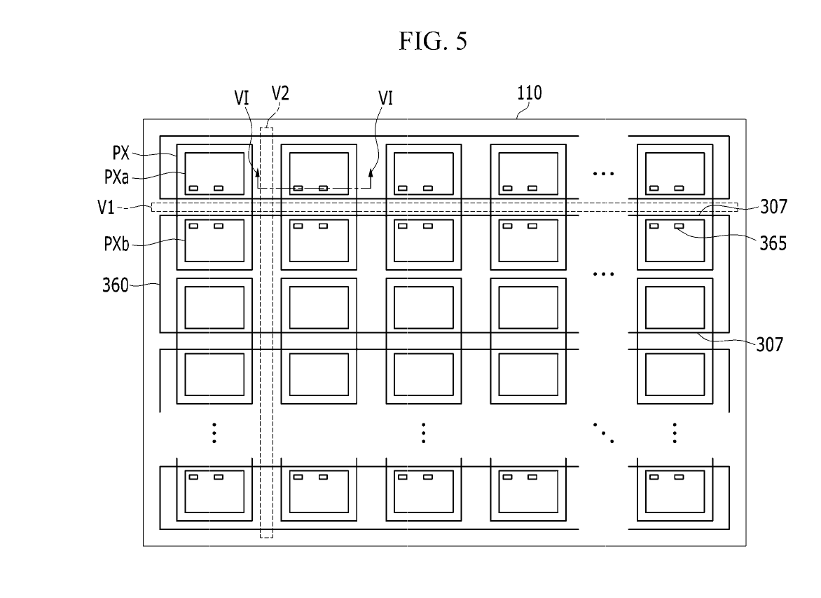

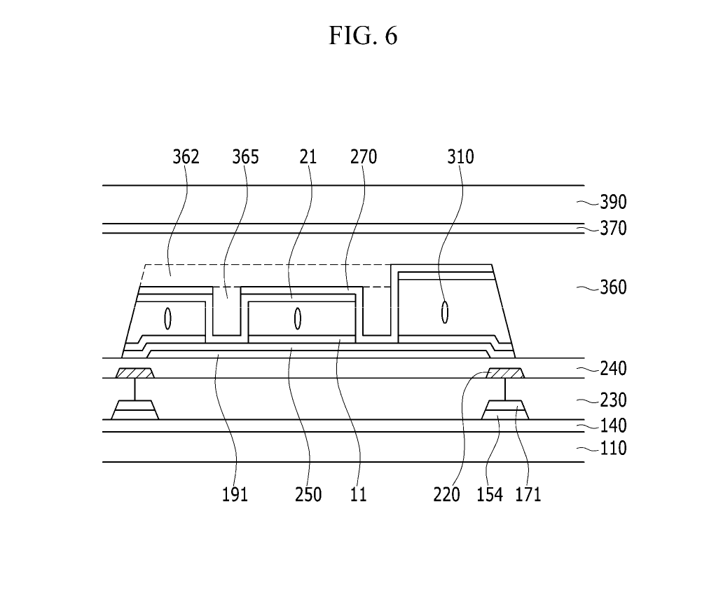

Although not illustrated, polarizers may be further formed on the upper and lower surfaces of the display device. The polarizers may include a first polarizer and a second polarizer. The first polarizer may be attached onto the lower surface of the substrate 110, and the second polarizer may be attached onto the overcoat 390. FIG. 5 is a schematic plan view (or schematic layout view) illustrating a display device according to an embodiment. FIG. 6 is a schematic cross-sectional view taken along line VI-VI indicated in FIG. 6 according to an embodiment. The display device associated with FIG. 5 and FIG. 6 may have features that are identical to or analogous to one or more of the features discussed with reference to FIG. 1, FIG. 2, FIG. 3, and FIG. 4. Description related to identical features and/or analogous features may not be repeated.

Referring to FIGS. 5 and 6, in the display device, two support members 365 are formed at an edge of a microcavity 305. Each of the two support members 365 may be directly connected to a stepped portion 362, which may extend from a lateral wall of the microcavity 305. The two support members 365 may strengthen a structure of the display device and may facilitate removal of unwanted elements in the process of manufacturing the display device.

In the display device, a liquid crystal layer may include a first liquid crystal portion, a second liquid crystal portion, and a third liquid crystal portion. The third liquid crystal portion may be positioned between the first liquid crystal portion and the second liquid crystal portion in a direction perpendicular to a data line 171. A first support member 365 may be positioned between the first liquid crystal portion and the third liquid crystal portion in the direction perpendicular to the data line 171. A second support member 365 may be positioned between the third liquid crystal portion and the second liquid crystal portion in the direction perpendicular to the data line 171.

The third liquid crystal portion may be larger than the first liquid crystal portion and/or may be smaller than the second liquid crystal portion.

A first side (e.g., lower side) of the first liquid crystal portion may be positioned between a second side (e.g., upper side) of the first liquid crystal portion and the substrate 110. A first side (e.g., lower side) of the second liquid crystal portion may be positioned between a second side (e.g., upper side) of the second liquid crystal portion and the substrate 110. A first side (e.g., lower side) of the third liquid crystal portion may be positioned between a second side (e.g., upper side) of the third liquid crystal portion and the substrate 110.

A distance between the second side of the first liquid crystal portion and the substrate 110 may be substantially equal to a distance between the second side of the third liquid crystal portion and the substrate 110 in the direction perpendicular to the substrate 110. The second side of the first liquid crystal portion may be narrower than the second side of the third liquid crystal portion in a direction perpendicular to a data line 171, in the pixel row direction and/or in the microcavity row direction.

The second side of the third liquid crystal portion may be positioned closer to the substrate 110 than the second side of the second liquid crystal portion in the direction perpendicular to the substrate 110. The second side of the first liquid crystal portion may be wider than the second side of the second liquid crystal portion in a direction perpendicular to a data line 171, in the pixel row direction and/or in the microcavity row direction.

The alignment layer 21 may include a first portion, a second portion, and a third portion, which may respectively directly contact the second side of the first liquid crystal portion, the second side of the second liquid crystal portion, and the second side of the third liquid crystal portion. A distance between the first portion of the alignment layer 21 and the pixel electrode 191 (and/or the substrate 110) may be substantially equal to a distance between the third portion of the alignment layer 21 and the substrate 110 in the direction perpendicular to the pixel electrode 191 (and/or the substrate 110). The third portion of the alignment layer 21 may be positioned closer to the pixel electrode 191 (and/or the substrate 110) than the second portion of the alignment layer 21.

The third portion of the alignment layer 21 may be wider than the first portion of the alignment layer 21 and may be narrower than the second portion of the alignment layer 21.

A fourth portion of the alignment layer 21 may be positioned between the first liquid crystal portion and the first support member 365. A fifth portion of the alignment layer 21 may be positioned between the third liquid crystal portion and the first support member 365.

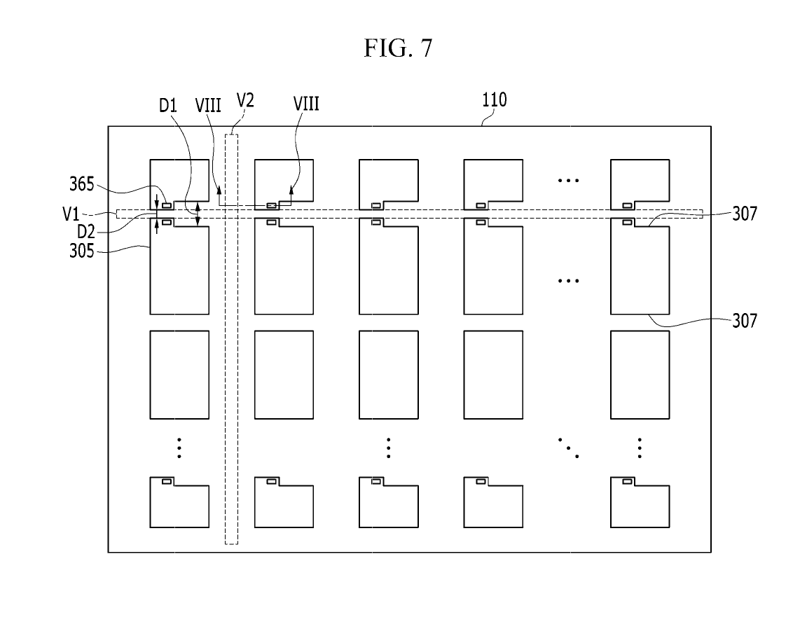

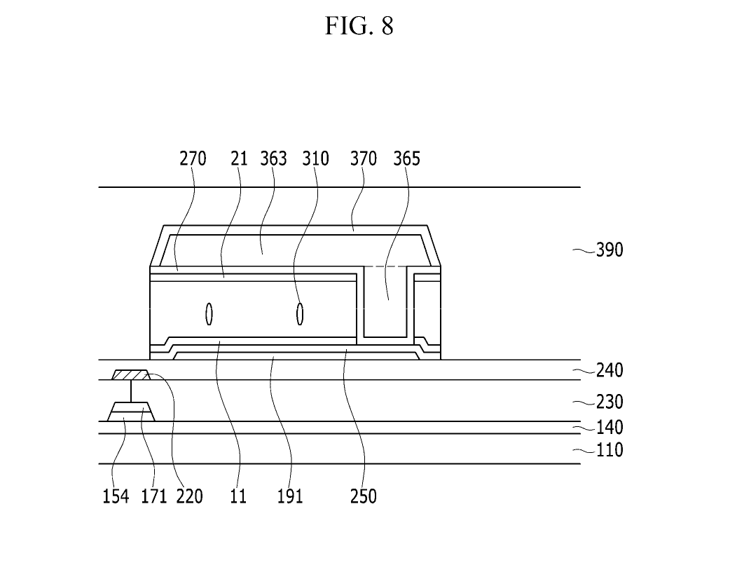

A first portion of the common electrode 270 may be positioned between the third liquid crystal portion and the second support member 365. A second portion of the common electrode 270 may be positioned between the second liquid crystal portion and the second support member 365. FIG. 7 is a schematic plan view (or schematic layout view) illustrating a display device according to an embodiment. FIG. 8 is a cross-sectional view taken along line VIII-VIII indicated in FIG. 7 according to an embodiment. The display device associated with FIG. 7 and FIG. 8 may have features that are identical to or analogous to one or more of the features discussed with reference to FIG. 1, FIG. 2, FIG. 3, FIG. 4, FIG. 5, and FIG. 6. Description related to identical features and/or analogous features may not be repeated.

Referring to FIGS. 1, 2, 3, 4, 7, and 8, a first roof layer 360 may be positioned on a first microcavity 305 (and a first liquid crystal layer) of the display device associated with FIGS. 7 and 8 and may overlap a first subpixel electrode in a first subpixel PXa. A second roof layer 360 may be positioned on a second microcavity 305 (and a second liquid crystal layer) of the display device associated with FIGS. 7 and 8 and may overlap a second subpixel electrode in a second subpixel PXb. The first subpixel PXa may be aligned with the second subpixel PXb in a direction parallel to a data line 171. A first portion 363 (or an extension 363) of the first roof layer 360 may overlap a support member 365 and may be positioned between a second portion of the first roof layer and a first portion (or an extension) of the second roof layer. The first portion of the second roof layer may be positioned between the first portion 363 of the first roof layer and the second portion of the second roof layer.

The first portion 363 (or extension 363) of the first roof layer (and the corresponding liquid crystal portion) may be narrower the second portion of the first roof layer (and the corresponding liquid crystal portion) in a direction perpendicular to the data line 171. The first portion (or extension) of the second roof layer (and the corresponding liquid crystal portion) may be narrower the second portion of the second roof layer (and the corresponding liquid crystal portion) in the direction perpendicular to the data line 171. A distance between D1 between the first portion 363 of the first roof layer and the first portion of the second roof layer is smaller than a distance D2 between the second portion of the first roof layer and the second portion of the second roof layer. The distance difference is also applicable to the liquid crystal portions corresponding to the roof layer portions.

The support member 365 may be positioned between a first portion of the first liquid crystal layer and a second portion of the first liquid crystal layer in the direction perpendicular to the data line 171. The first portion of the first liquid crystal layer may be smaller (e.g., narrower) than the second portion of the first liquid crystal layer in the direction perpendicular to the data line 171.

The support member 365 may be positioned between a first portion of the first microcavity 305 and a second portion of the first microcavity 305 in the direction perpendicular to the data line 171. The first portion of the first microcavity 305 may be smaller (e.g., narrower and/or shorter) than the second portion of the first microcavity 305 in the direction perpendicular to the data line 171. Therefore, unwanted elements (e.g., lumps and/or bubbles) that are formed during formation of the first liquid crystal layer and/or during formation of related alignment layers may substantially concentrate at the first portion of the first microcavity 305 and may be effectively removed. Advantageously, defects in the display device may be minimized.

Referring to FIG. 7 and FIG. 8, the first portion (e.g., right portion) of the first microcavity 305 may be narrower than the second portion (e.g., left portion) of the first microcavity 305 in the direction perpendicular to the data line 171. In an embodiment, a side (e.g., upper side) of the first portion of the first microcavity 305 may be closer to the substrate 110 than a side (e.g., upper side) of the second portion of the first microcavity 305.

The support member 365 may strengthen a structure of the first roof layer 360 and/or a structure of the display device. Advantageously, the structure of the display device may be satisfactorily robust.

A portion of a light blocking member 220 may extend perpendicular to the data line 171 and may overlap with the supporting member 365. Therefore, even if the aforementioned unwanted elements are not completely removed, the unwanted elements may be substantially concealed and may not affect quality of images displayed by the display device. Given the small distance D1, the portion of the light blocking member 220 that cover the support member 365 may be substantially small. Therefore, an aperture ratio of the display device may be maximized. Advantageously, satisfactory brightness of images displayed by the display device may be attained, and/or power consumption of the display device may be minimized.

The distance D1 may be in a range of about 10 microns to about 30 microns. The distance D2 may be in a range of about 40 microns to about 60 microns.

According to embodiments, a display device may be manufactured with a single substrate. Advantageously, thickness, weight, cost, and/or manufacturing time associated with the display device may be minimized.

According to embodiments, unwanted elements (e.g., lumps and/or bubbles) may be effectively removed in a process of manufacturing a display device. Advantageously, defects in the display device may be minimized, and images displayed by the display device may be satisfactory.

According to embodiments, a support member may effectively prevent deformation of a roof layer in a display device. Advantageously, the display device may have a satisfactorily robust structure.

While some embodiments have been described as examples, possible embodiments are not limited to the described embodiments. Embodiments are intended to cover various modifications and equivalent arrangements within the spirit and scope defined by the appended claims.

What is claimed is:

1. A display device comprising:
a substrate;
a first roof layer, which overlaps the substrate;
a pixel electrode, which is positioned between the first roof layer and the substrate;
a liquid crystal layer, which is positioned between the first roof layer and the pixel electrode and comprises a first liquid crystal portion and a second liquid crystal portion, wherein the first liquid crystal portion is smaller than the second liquid crystal portion; and
a first support member, which is positioned between the first roof layer and the substrate and is positioned between the first liquid crystal portion and the second liquid crystal portion.

2. The display device of claim 1, wherein the liquid crystal layer surrounds four sides of the first support member.

3. The display device of claim 1, wherein each of the first liquid crystal portion and the second liquid crystal portion overlaps the pixel electrode in a direction perpendicular to the substrate.

4. The display device of claim 1 further comprising:
a semiconductor, which is electrically connected to the pixel electrode; and
a data line, which is electrically connected to the semiconductor,
wherein the first support member is positioned between the first liquid crystal portion and the second liquid crystal portion in a direction parallel to the data line.

5. The display device of claim 1,
wherein the pixel electrode comprises a first subpixel electrode and a second subpixel electrode,
wherein the liquid crystal layer overlaps the first subpixel electrode, and
wherein the first liquid crystal portion is positioned closer to the second subpixel electrode than the second liquid crystal portion.

6. The display device of claim 1 further comprising:
a semiconductor, which is electrically connected to the pixel electrode; and
a data line, which is electrically connected to the semiconductor,
wherein the first support member is positioned between the first liquid crystal portion and the second liquid crystal portion in a direction perpendicular to the data line.

7. The display device of claim 6,
wherein the liquid crystal layer comprises a third liquid crystal portion and a fourth liquid crystal portion,
wherein the third liquid crystal portion is smaller than the fourth liquid crystal portion, and
wherein the first support member is positioned between the third liquid crystal portion and the fourth liquid crystal portion in a direction parallel to the data line.

8. The display device of claim 6,
wherein a first side of the first liquid crystal portion is positioned between a second side of the first liquid crystal portion and the substrate,
wherein a first side of the second liquid crystal portion is positioned between a second side of the second liquid crystal portion and the substrate, and
wherein the second side of the first liquid crystal portion is positioned closer to the substrate than the second side of the second liquid crystal portion.

9. The display device of claim 6,
wherein a first side of the first liquid crystal portion is positioned between a second side of the first liquid crystal portion and the substrate,
wherein a first side of the second liquid crystal portion is positioned between a second side of the second liquid crystal portion and the substrate, and
wherein the second side of the first liquid crystal portion is narrower than the second side of the second liquid crystal portion.

10. The display device of claim 6 further comprising:
a second support member,
wherein the liquid crystal layer comprises a third liquid crystal portion,
wherein the third liquid crystal portion is positioned between the first liquid crystal portion and the second liquid crystal portion in the direction perpendicular to the data line,
wherein the first support member is positioned between the first liquid crystal portion and the third liquid crystal portion in the direction perpendicular to the data line, and
wherein the second support member is positioned between the third liquid crystal portion and the second liquid crystal portion in the direction perpendicular to the data line.

11. The display device of claim 10, wherein the third liquid crystal portion is larger than the first liquid crystal portion.

12. The display device of claim 10, wherein the third liquid crystal portion is smaller than the second liquid crystal portion.

13. The display device of claim 10,
wherein a first side of the first liquid crystal portion is positioned between a second side of the first liquid crystal portion and the substrate,
wherein a first side of the third liquid crystal portion is positioned between a second side of the third liquid crystal portion and the substrate, and
wherein the second side of the first liquid crystal portion is narrower than the second side of the third liquid crystal portion.

14. The display device of claim 10,
wherein a first side of the third liquid crystal portion is positioned between a second side of the third liquid crystal portion and the substrate,
wherein a first side of the second liquid crystal portion is positioned between a second side of the second liquid crystal portion and the substrate, and
wherein the second side of the third liquid crystal portion is positioned closer to the substrate than the second side of the second liquid crystal portion.

15. The display device of claim 10,
wherein a first side of the third liquid crystal portion is positioned between a second side of the third liquid crystal portion and the substrate,
wherein a first side of the second liquid crystal portion is positioned between a second side of the second liquid crystal portion and the substrate, and
wherein the second side of the first liquid crystal portion is wider than the second side of the second liquid crystal portion.

16. The display device of claim 10 further comprising:
a common electrode, which overlaps the pixel electrode,
wherein a portion of the common electrode is positioned between the third liquid crystal portion and the second support member and directly contacts each of the third liquid crystal portion and the second support member.

17. The display device of claim 16 further comprising:
an alignment layer, which directly contact the liquid crystal layer and is configured to orient a direction of a liquid crystal molecule in the liquid crystal layer,
wherein a portion of the alignment layer is positioned between the third liquid crystal portion and the first support member and directly contacts each of the third liquid crystal portion and the first support member.

18. The display device of claim 1 further comprising:
a common electrode, which overlaps the pixel electrode,
wherein a portion of the common electrode is positioned between the second liquid crystal portion and the first support member and directly contacts each of the second liquid crystal portion and the first support member.

19. The display device of claim 1 further comprising:
a second roof layer, which is aligned with the first roof layer in an alignment direction,
wherein the pixel electrode comprises a first subpixel electrode and second subpixel electrode,
wherein the first roof layer overlaps the first subpixel electrode,
wherein the second roof layer overlaps the second subpixel electrode,
wherein a first portion of the first roof layer overlaps the first support member in a direction perpendicular to the substrate,
wherein a second portion of the first roof layer does not overlap the first support member in the direction perpendicular to the substrate,
wherein the first portion of the first roof layer is positioned between the second roof layer and the second portion of the first roof layer in the alignment direction, and
wherein the first portion of the first roof layer is narrower than the second portion of the first roof layer in a direction perpendicular to the alignment direction.

20. The display device of claim 19 further comprising:
a second support member,
wherein a first portion of the second roof layer overlaps the second support member in the direction perpendicular to the substrate,
wherein a second portion of the second roof layer does not overlap the second support member in the direction perpendicular to the substrate, and
wherein a distance between the first portion of the first roof layer and the first portion of the second roof layer is smaller than a distance between the second portion of the first roof layer and the second portion of the second roof layer in the alignment direction.
